(19) United States
(12) Patent Application Publication
(10) Pub. No.: US 2013/0106970 A1
(43) Pub. Date: May 2, 2013

(54) NAIL PRINT APPARATUS INCLUDING DISPLAY CONTROL UNIT WHICH DISTINGUISHES BETWEEN PRINTED REGION AND NON-PRINTED REGION IN FINGERNAIL UNDER PRINTING TO DISPLAY FINGERNAIL

(71) Applicant: Casio Computer Co., Ltd., Tokyo (JP)

(72) Inventor: Shuichi YAMASAKI, Tokyo (JP)

(73) Assignee: CASIO COMPUTER CO., LTD., Tokyo (JP)

(21) Appl. No.: 13/661,499

(22) Filed: Oct. 26, 2012

(30) Foreign Application Priority Data
Oct. 28, 2011 (JP) 2011-236657

(51) Int. Cl. B41J 2/00

(52) U.S. Cl. 347/110

(57) ABSTRACT

A nail print apparatus, including a print head which performs printing on a fingernail of a user; a display unit; and a display control unit which displays a printing image on the display unit so that the user can distinguish between a printed region and a non-printed region in the printing image being printed on the nail.

### BACKGROUND OF THE INVENTION

1. Field of the Invention

The present invention relates to a nail print apparatus including a display control unit which distinguishes between a printed region and a non-printed region in a fingernail which is under printing to display the fingernail.

2. Description of Related Art

Nail print apparatuses which print nail designs of various colors, pictures and such like on fingernails are suggested in Japanese Patent Application Laid Open Publication No. 2000-194838 and Japanese Patent Application Laid Open Publication No. 2002-165632 By using such nail print apparatus, a user can enjoy nail printing easily at home or the like without going to a shop such as a nail salon.

When fingernails are to be printed by using a nail print apparatus, the fingers are placed on a placement board and printing is performed on the fingernails by a printing unit of the nail print apparatus. When the fingers are merely placed on the placement board, the fingers may move since the hand is unsettled, and the printed images may be out of positions or may blur. Therefore, the user has to keep the fingers still firmly.

However, it, is painful for a user to keep the fingers for a long time until the end of the printing on the fingernails. Thus, such pain can be eased if the user can grasp the time it takes until the end of the printing and the progress of the printing. However, since the printing unit is located above the fingers during printing, a user cannot grasp the time it takes until the end of the printing and the progress.

Therefore, the problem to be solved by the present invention is to provide a nail print apparatus which can let a user know the progress of printing and the time it takes until the end of the printing.

### SUMMARY OF THE INVENTION

According to one aspect of the present invention, there is provided a nail print apparatus, including a print head which performs printing on a fingernail of a user; a display unit; and a display control unit which displays a printing image on the display unit so that the user can distinguish between a printed region and a non-printed region in the printing image being printed on the nail.

### BRIEF DESCRIPTION OF THE DRAWINGS

The above and other objects, advantages and features of the present invention will become more fully understood from the detailed description given hereinafter and the appended drawings which are given by way of illustration only, and thus are not intended as a definition of the limits of the present invention, and wherein:

FIG. 1 is a schematic view conceptually showing an embodiment of a nail print apparatus according to the present invention and shows a state where a cover is open;

FIG. 2 is a schematic view conceptually showing an apparatus main body of the nail print apparatus of FIG. 1;

FIG. 3 is a sectional view showing a printing finger fixing unit of the nail print apparatus of FIG. 1 and shows a fix state of fingers when an index finger, middle finger, ring finger and little finger as printing fingers are inserted into a printing finger insertion unit;

FIG. 4 is a sectional view seen from the front side of the nail print apparatus of FIG. 1;

FIG. 5 is a sectional view seen from a side of the nail print apparatus of FIG. 1;

FIG. 6 is a main part block diagram showing a control structure of a nail print apparatus according to the embodiment;

FIG. 7 is a diagram showing an example of a display screen;

FIG. 8 is a diagram showing an example of a display screen;

FIG. 9 is a diagram showing an example of a display screen;

FIG. 10 is a flowchart showing a flow of processing performed by a control unit of the nail print apparatus;

FIG. 11 is a diagram showing an example of a display screen.

### DETAILED DESCRIPTION OF THE PREFERRED EMBODIMENT

Hereinafter, an embodiment of the present invention will be described using drawings. However, the scope of the present invention is not limited to the following embodiment and illustrated examples though the embodiment described below is accompanied with various limitations which are technically preferable to perform the present invention.

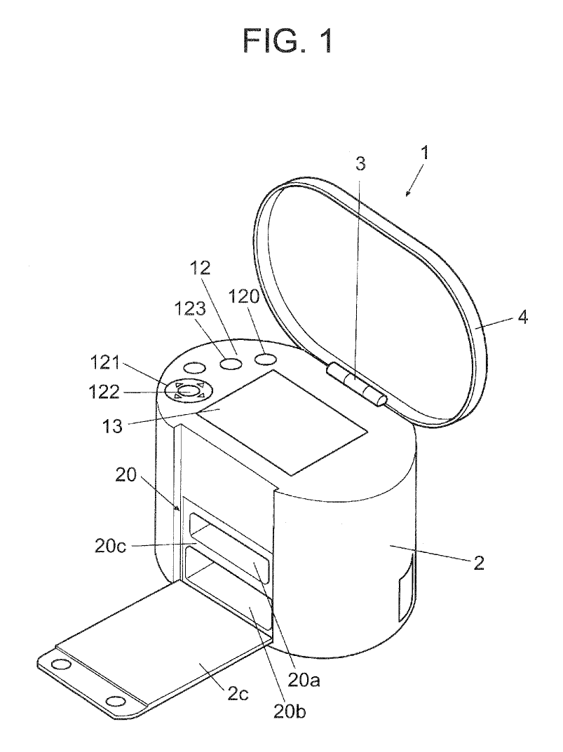

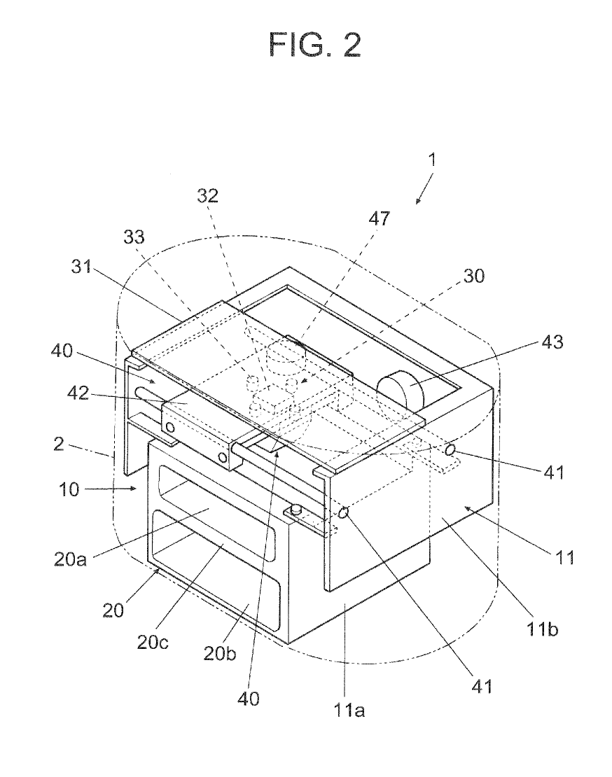

FIG. 1 is a schematic view showing an outer appearance of a nail print apparatus in the embodiment and FIG. 2 is a schematic view showing inner structure of the nail print apparatus.

As shown in FIG. 1, the nail print apparatus 1 includes a case main body 2 and a cover 4. The case main body 2 and the cover 4 are joined to each other via a hinge 3 which is provided at the rear end portion of the upper surface of the case main body 2.

The above case main body 2 is formed in an oval shape in a plan view. An opening/closing plate 2c is provided at the front side of the case main body 2 so as to be able to flip up and down. The opening/closing plate 2c is joined to the case main body 2 via a hinge (not shown in the drawings) which is provided at the lower end portion of the front surface of the case main body 2. The opening/closing plate 2c is for opening and closing the front surface of the case main body 2.

Further, an after-mentioned operation unit 12 is set on the upper surface (top plate) of the case main body 2 and a display unit 13 is set at the nearly central portion of the upper surface (top plate).

Shapes and structures of the case main body 2 and the cover 4 are not limited to the example illustrated here.

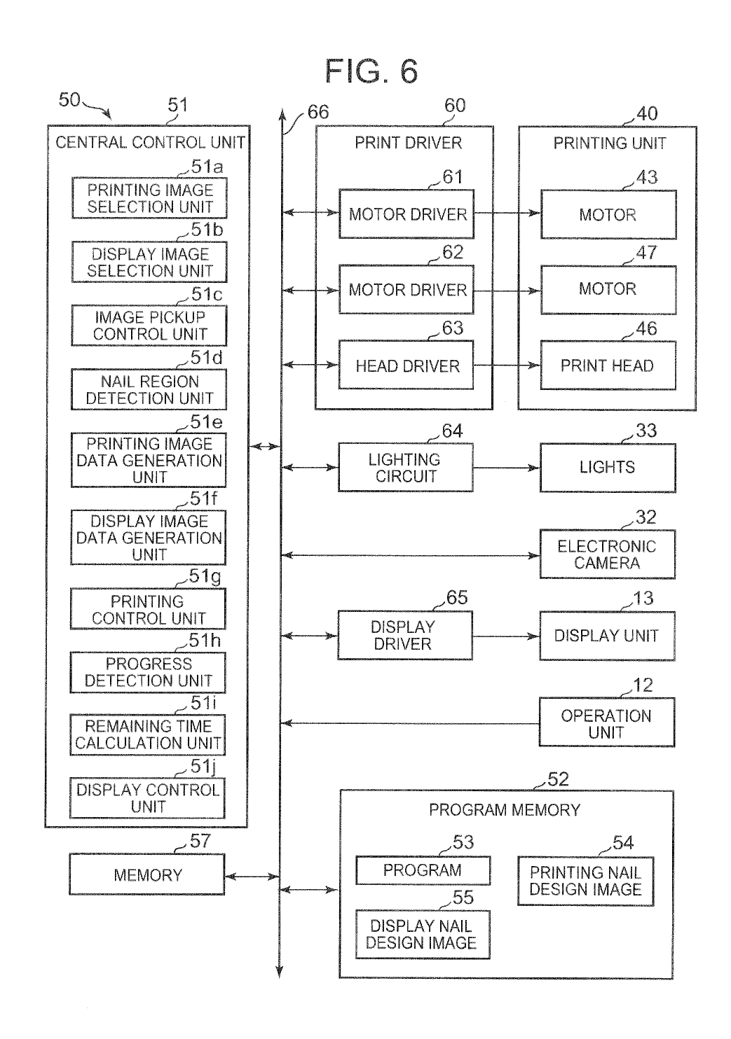

Also, an apparatus main body 10 of the nail print apparatus 1 is housed in the case main body 2. The apparatus main body 10 includes a printing finger fixing unit 20, a image pickup unit 30, a printing unit 40, a control device 50 (see FIG. 6) and the like as shown in FIG. 2. The printing finger fixing unit 20, the image pickup unit 30, the printing unit 40 and the control device 50 are provided in a machine casing 11.

Here, the machine casing 11 includes a lower machine casing 11a and an upper machine casing 11b. The lower machine casing 11a is formed in a box shape and is set at the lower section inside the case main body 2. The upper machine casing 11b is set above the lower machine casing 11a and at the upper section inside the case main body 2.

The printing finger fixing unit 20 is provided in the lower machine casing 11a of the machine casing 11. The printing finger fixing unit 20 is configured by including a printing finger insertion unit 20a, a non-printing finger insertion unit 20b and a holding unit 20c which are provided in the lower machine casing 11a.

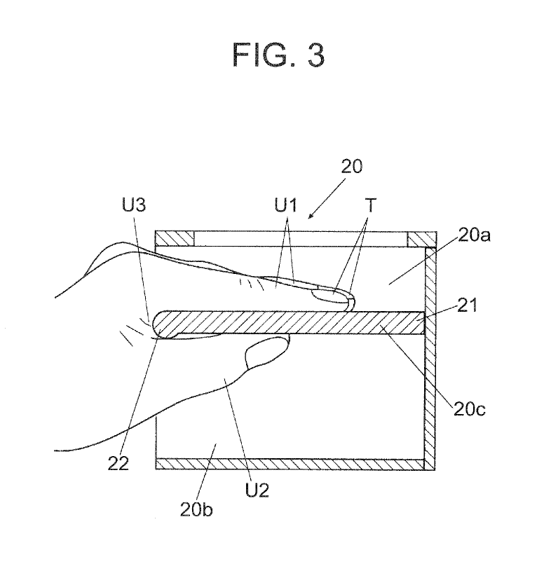

Here, the printing finger insertion unit 20a is a finger insertion unit for inserting fingers (hereinafter, called “printing fingers”) U1 corresponding to nails T to be printed (see FIG. 3). The bottom surface (printing finger placement surface) of the printing finger insertion unit 20a functions as a finger placement unit to place the printing fingers U1. Photographing and printing of the printing fingers U1 are performed in a state where the printing fingers U1 are placed on the printing finger placement surface of the printing finger insertion unit 20a as the finger placement unit.

Further, the non-printing finger insertion unit 20b is a printing finger insertion unit for inserting a finger (hereinafter called “non-printing finger”) U2 other than the printing fingers (see FIG. 3).

In addition, the holding unit 20c is a part which can be held between the printing fingers U1 inserted in the printing finger insertion unit 20a and the non-printing finger U2 inserted in the non-printing finger insertion unit 20b. In the embodiment, the holding unit 20c includes a dividing wall 21 which divides the printing finger insertion unit 20a from the non-printing finger insertion unit 20b.

The upper surface of the dividing wall 21 includes a printing finger placement surface which is flat. A bulging portion 22 is formed at the end of the dividing wall 21 from where fingers are inserted. The bulging portion 22 is formed at a part where bases U3 of the printing fingers U1 and the non-printing finger U2 abut when the printing fingers U1 and the non-printing finger U2 are deeply inserted in the printing finger insertion unit 20a and the non-printing finger insertion unit 20b, respectively. The cross-section of the bulging portion 22 when cut along the finger insertion direction is circular so as to bulge downward from the lower surface of the dividing wall 21 so that the dividing wall 21 (the holding unit 20c) can be held firmly between the printing fingers U1 and the non-printing finger U2 in a state where the entire balls of the printing fingers U1 abut the printing finger placement surface. The shape of the bulging portion 22 is not limited to the cross-sectional circle, and may be a cross-sectional oval and a non-circle such as a polygon.

For example, in a case where four fingers (index finger, middle finger, ring finger and little finger) other than the thumb are printing fingers U1, as shown in FIG. 3, the user inserts the four printing fingers U1 to the printing finger insertion unit 20a and inserts the thumb which is the non-printing finger U2 to the non-printing finger insertion unit 20h. In this case, the printing fingers U1 are fixed on the holding unit 20c by the user holding the holding unit 20c between the printing fingers U1 inserted to the printing finger insertion unit 20a and the non-printing finger U2 inserted to the non-printing finger insertion unit 20b.

Also, in a case where only the thumb is a printing finger U1, the thumb (printing finger U1) is inserted in the printing finger insertion unit 20a and the four fingers (non-printing fingers U2) other than the thumb are inserted in the non-printing finger insertion unit 20b. In this case, the printing finger U1 is also fixed by the user holding the holding unit 20c between the printing finger U1 and the non-printing fingers U2.

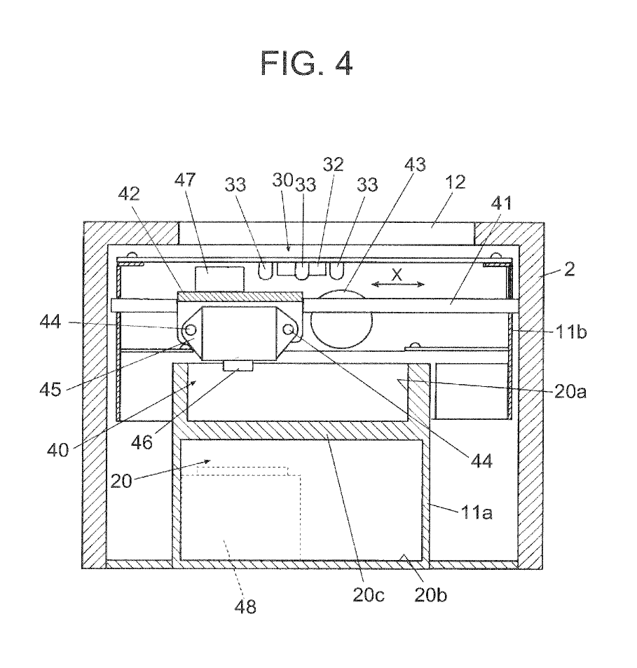

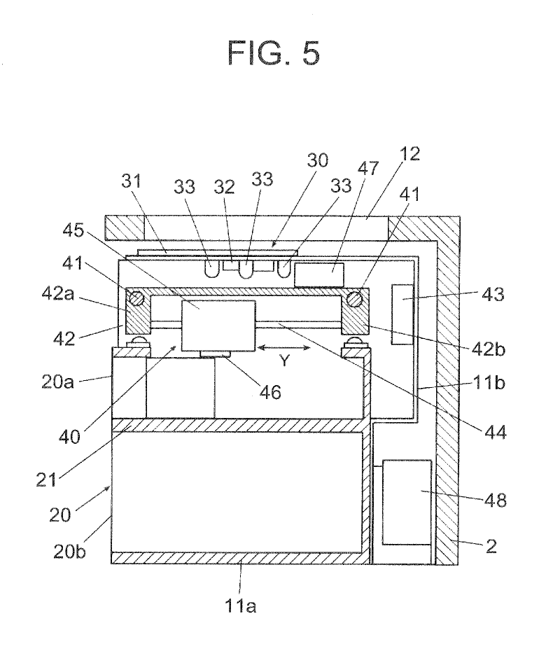

FIG. 4 is a sectional view seen from the front side of the nail print apparatus 1 according to the embodiment and FIG. 5 is a sectional view seen from a side of the nail print apparatus 1.

As shown in FIGS. 4 and 5, the image pickup unit 30 is provided on the upper machine casing lib of the machine casing 11.

That is, at the central portion of the lower surface of a substrate 31 which is set on the upper machine casing 11b, an electronic camera 32 of approximately two million pixels or more which includes a built-in driver is set. In addition, on the substrate 31, lights 33 such as white LEDs are set so as to surround the electronic camera 32. The image pickup unit 30 is configured by including the electronic camera 32 and the lights 33.

The image pickup unit 30 is a fingernail image obtaining unit which obtains a finger image including a nail region image of the nail T corresponding to the printing finger U1 by illuminating the printing finger U1 placed in the printing finger insertion unit 20a which is the finger placement unit with the lights 33 and photographing the printing finger U1 with the electronic camera 32. The image pickup unit 30 is connected to an after-mentioned control device 50 and is controlled by the control device 50.

Also, the printing unit 40 performs printing of colors, patterns and such like on a nail T (see FIG. 3, for example) of a printing finger U1. In the embodiment, the printing unit 40 is mainly provided in the upper machine casing lib. That is, as shown in FIGS. 4 and 5, two guide rods 41 are bridged in parallel to each other between the both side boards of the upper machine casing lib. A main carriage 42 is slidably set at the guide rods 41. In addition, as shown in FIG. 5, two guide rods 44 are bridged in parallel to each other between a front wall 42a and a rear wall 42b of the main carriage 42. A secondary carriage 45 is slidably set at the guide rods 44. A print head 46 is mounted on the central portion of the lower surface of the secondary carriage 45.

In the embodiment, the print head 46 is an ink-jet type print head which makes ink be in the form of micro droplets and directly sprays the ink droplets onto a target to be printed to perform printing. Here, the recording method of the print head 46 is not limited to the ink-jet type.

The main carriage 42 is joined to a motor 43 via a power transmission unit (not shown in the drawings). The main carriage 42 is configured to move to the left and right along the guide rods 41 above the printing finger insertion unit 20a and the dividing wall 21 by the forward-reverse rotation of the motor 43. Also, the secondary carriage 45 is joined to a motor 47 via a power transmission unit (not shown in the drawings). The secondary carriage 45 is configured to move back and forth along the guide rods 44 above the printing finger insertion unit 20a and the dividing wall 21 by the forward-reverse rotation of the motor 47. The left and right direction along the guide rods 41 is X direction, the front and back direction along the guide rods 44 is Y direction and the positions of the print head 46 and the nail T of the printing finger U1 are shown in XY orthogonal coordinate system.

Further, an ink cartridge 48 for supplying ink to the print head 46 is provided in the lower machine casing 11a. The ink cartridge 48 connected to the print head 46 via an ink supply tube (not shown in the drawing), and appropriately supplies ink to the print head 46. Here, the configuration may be such that the ink cartridge is mounted on the print head 46 itself.

The printing unit 40 is configured by including the guide rods 41, the main carriage 42, the motor 43, the guide rods 44, the secondary carriage 45, the print head 46, the motor 47, the ink cartridge 48 and others.

The operation unit 12 is an input device for a user to perform various types of input. When the operation unit 12 is operated by a user, the operation unit 12 outputs an operation signal according to the operation. In the embodiment, as shown in FIG. 1, the operation unit 12 is provided with a power button 120 which turns on the nail print apparatus 1, a setting button 121 which specifies a nail design image, an OK button 122 for deciding various types of specification or selection, a print button 123 which is a switch to start printing and the like, for example.

The display unit 13 is a display unit which is configured by including a liquid crystal panel (LCD: Liquid Crystal Display), for example.

A touch panel may be integrally formed on the surface of the display unit 13. In such case, it is configured so that various types of input can also be carried out by touching the surface of the display unit 13 by touching operation with a stylus pen (not shown in the drawings), a fingertip and the like.

On the display unit 13, for example, a finger image obtained by photographing a printing finger U1, a nail region image which shows a nail T in the finger image, a nail design to be printed on the nail T of the printing finger U1, thumbnail images for design confirmation, various types of instruction screens and such like are displayed. Contents displayed on the display unit 13 during printing will be described in detail later.

The control device 50 is set on the substrate 31 disposed on the upper machine casing lib and the like, for example. FIG. 6 is a main part block diagram showing a control structure in the embodiment.

As shown in FIG. 6, the control device 50 includes a central control unit 51, a program memory 52, a memory 57, a print driver 60, a lighting circuit 64, a display driver 65, a bus line 66 and the like. The print driver 60 includes a motor driver 61, a motor driver 62, a head driver 63 and the like.

The central control unit 51, the program memory 52, the memory 57, the motor driver 61, the motor driver 62, the head driver 63, the lighting circuit 64, the electronic camera. 32, the display driver 65 and the operation unit 12 are connected to the bus line 66. Through the bus line 66, data and signals are transferred to or from the central control unit 51, the program memory 52, the memory 57, the motor driver 61, the motor driver 62, the head driver 63, the lighting circuit 64, the electronic camera 32, the display driver 65 and the operation unit 12.

The motor driver 61 drives the motor 43 according to the instruction of the central control unit 51. The motor driver 62 drives the motor 47 according to the instruction of the central control unit 51. The head driver 63 drives the print head 46 according to the instruction of the central control unit 51. The lighting circuit 64 turns on and off and dims the lights 33 according to the instruction of the central control unit 51. The display driver 65 drives the display unit 13 according to the instruction of the central control unit 51.

In the program memory 52, a plurality of printing nail design image data 54 are stored. The printing nail design image data 54 are images to be printed on a nail T of a printing finger U1.

In the program memory 52, a plurality of display nail design image data 55 are stored. The display nail design image data 55 are images to be displayed on the display unit 13 during printing and has an appropriate resolution and an appropriate number of pixels to be displayed on the display unit 13. These printing nail design image data 54 and display nail design image data 55 correspond one-to-one, respectively. A printing nail design image data 54 and a display nail design image data 55 corresponding to the printing nail design image data 54 are same images having different resolution and different number of pixels.

The printing nail design image data 54 and the display nail design image data 55 may be stored in an external storage medium (for example, semiconductor memory or hard disk drive). In such case, when a reader/writer is connected to the bus line 66 and the external storage medium is attached to the reader/writer, the printing nail design image data 54 and the display nail design image data 55 stored in an external storage medium can be read out by the reader/writer.

In the program memory 52, a program 53, data and such like according to functions of the nail print apparatus 1 are stored. This program 53 is a program readable by the central control unit 51.

The memory 57 is used as a working memory and the like of the central control unit 51.

The central control unit 51 includes CPU which controls each unit of the nail print apparatus 1, and the like. The program 53 makes the central control unit 51 have various types of functions and the central control unit 51 performs various types of processing according to the program 53. Specifically, the program 53 makes the central control unit 51 function as a printing image selection unit 51a, a display image selection unit 51b, an image pickup control unit 51c, a nail region detection unit 51d, a printing image data generation unit 51e, a display image data generation unit 51f, a printing control unit 51g, a progress detection unit 51h, a remaining time calculation unit 51i and a display control unit 51j.

The printing image selection unit 51a selects an image to print among the plurality of printing nail design image data 54 stored in the program memory 52 according to an operation signal output from the operation unit 12.

The display image selection unit 51b selects the display nail design image data 55 corresponding to the printing nail design image data 54 selected by the printing image selection unit 51a among the plurality of display nail design image data 55 stored in the program memory 52.

The image pickup control unit 51c makes the electronic camera 32 perform image pickup and obtains the image picked up by the electronic camera 32.

The nail region detection unit 51d detects the location, size and range of a nail T of a printing finger U1 which is inserted into the printing finger insertion unit 20a from the picked-up image obtained by the image pickup control unit 51c. Specifically, the nail region detection unit 51d recognizes a nail region and the edge thereof included in the picked-up image, and detect the location of each point on the edge of the nail region by performing image processing such as edge detection processing on the picked-up image obtained by the image pickup control unit 51c. Then, the nail region detection unit 51d converts the location (coordinate) of each point on the edge shown in the coordinate system of the picked up image into the location (coordinate) of each point on the outline of the nail T shown in XY orthogonal coordinate system.

The printing image data generation unit 51e generates printing image data from the printing nail design image data 54 which is selected by the printing image selection unit 51a. That is, the printing image data generation unit 51e converts the coordinate of each pixel in the printing nail design image data 54 into the coordinate in the XY orthogonal coordinate system by performing coordinate conversion on the printing nail design image data 54 which is selected by the printing image selection unit 51a. The printing nail design image data 54 after the coordinate conversion is called printing image data.

The display image data generation unit 51f generates display image data from the display nail design image data 55 which is selected by the display image selection unit 51k). That is, the display image data generation unit 51f converts the coordinate of each pixel in the display nail design image data 55 into the coordinate in the coordinate, system of the picked-up image by performing coordinate conversion on the display nail design image data 55 which is selected by the display image selection unit 51b. The display nail design image data 55 after the coordinate conversion is called display image data.

The printing control unit 51g controls the printing unit 40 (the motor 43, the motor 47 and the print head 46) via the print driver 60 (the motor driver 61, the motor driver 62 and the head driver 63) and makes the printing unit 40 print the printing image data on the nail T of the printing finger U1.

The progress detection unit 51h detects the progress of printing which is progressing under the control of the printing control unit 51g. Specifically, the progress detection unit 51h discriminates between the region which is already printed (hereinafter, called printed region) and the region which is not printed yet (hereinafter, called non-printed region) in the printing image data. Also, the progress detection unit 51h discriminates the region corresponding to the printed region (hereinafter, printed region corresponding region) and the region corresponding to the non-printed region (called non-printed region corresponding region) in the display image data.

As a method of distinguishing between the printed region and non-printed region, data amount of an image of nail design to be printed on one fingernail which is sent to a memory and data amount at the present moment which is already printed are compared, and a partial image corresponding to the proportion of the data amount at the present moment which is already printed is displayed on the display unit as the printed region. Alternatively, for example, when an estimated printing time period for printing an image on one fingernail is 20 seconds and 5 seconds passed from the start of printing, calculation of 5 seconds/20 seconds indicates that the printed region is 25% and the non-printed region is 75%, and 25% of the image of nail design to be printed may be displayed as the printed region. Alternatively, a proportion of the printed region may be calculated from movement amount of the print head which is estimated from the image area of the nail design to be printed on one fingernail sent to a memory and movement, amount at a certain point during printing indicating the actual movement of the print head, and a partial image corresponding to the calculated, proportion may be displayed on the display unit as the printed region.

The remaining time calculation unit 51i calculates the remaining time until the end of the printing which is progressing under the control of the printing control unit 51g.

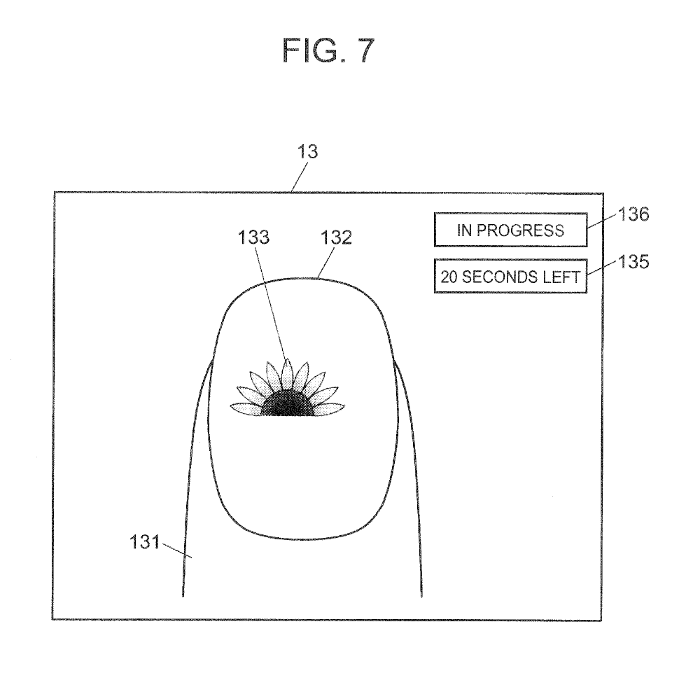

The display control unit 51j displays various types of images on the display unit 13 by controlling the display unit 13 via the display driver 65. Specifically, in the display image data, the display control unit 51j displays the printed region corresponding region which corresponds to the printed region discriminated by the progress detection unit 51h on the display unit 13 and does not display the non-printed region corresponding region which corresponds to the non-printed region discriminated by the progress detection unit 51h. When displaying the printed region, the display control unit 51j combines the printed region corresponding region with the picked-up image so that the printed region responding region is placed inside the edge of the nail region in the picked-up image which is obtained by the image pickup control unit 51c to display the printed region corresponding region on the display unit 13 together with the picked-up image. In addition, the display control unit 51j also displays the remaining time calculated by the remaining time calculation unit 51i on the display unit 13. An example of the screen displayed on the display unit 13 which is controlled by the display control unit 51j is shown in FIG. 7.

As shown in FIG. 7, on the display unit 13, a picked-up image (finger image) 131 obtained by the image pickup control unit 51c is displayed. The displayed picked-up image 131 includes the nail region (nail image) 132. The printed region corresponding region 133 which corresponds to the printed region discriminated by the progress detection unit 51h within the display image data is displayed so as to be disposed inside the nail region 132. That is, a display control unit displays a printing image on the display unit 13 so that a user can distinguish between a printed region and a non-printed region in the printing image being printed on the nail This printing image refers to the image to be finally printed. However, besides this, this printing image contains not only the image of the printed region already printed in the middle of printing but also the image of the non-printed region to be printed from now on. Also, a remaining time display region 135 is disposed at a corner of the display screen and the remaining time calculated by the remaining time calculation unit 51i is displayed inside the remaining time display region 135 numerically. Further, a printing status display region 136 is disposed near the remaining time display region 135, and indication that the apparatus is in printing is displayed in the printing status display region 136.

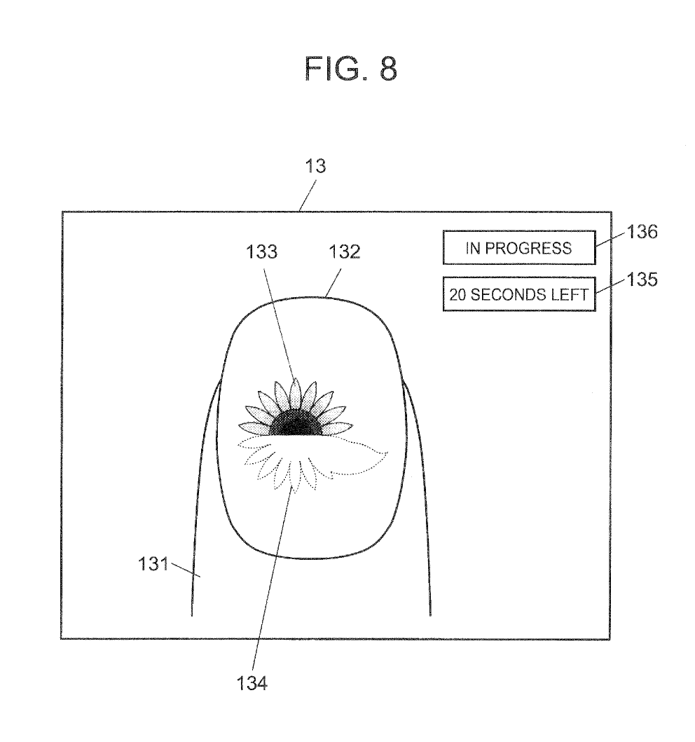

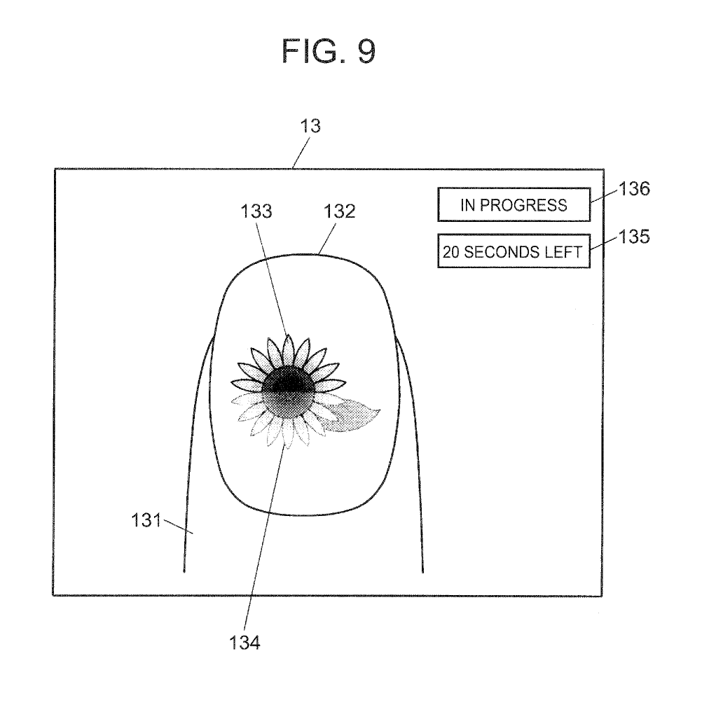

The above does not necessarily mean that the display control unit 51j does not display the non-printed region corresponding region. The display control unit 51j may display the non-printed region corresponding region and the printed region corresponding region on the display unit 13 by distinguishing between the non-printed region corresponding region and the printed region corresponding region. In the distinguishing display between the non-printed region corresponding region and the printed region corresponding region, the display control unit 51j combines the non-printed region corresponding region and the printed region corresponding region with the picked-up image so as to dispose the non-printed region corresponding region and the printed region corresponding region inside the edge of the nail region in the picked-up image obtained by the image pickup control unit 51c, and the display control unit 51j displays the non-printed region corresponding region and the printed region corresponding region on the display unit 13 together with the picked-up image. In addition, the display control unit 51j also displays the remaining time calculated by the remaining time calculation unit 51i on the display unit 13 together with the non-printed region corresponding region and the printed region corresponding region. Examples of screens to be displayed on the display unit 13 controlled by the display control unit 51j are shown in FIGS. 8 and 9.

As shown in FIGS. 8 and 9, on the display unit 13, the picked-up image 131 obtained by the image pickup control unit 51c is displayed. The displayed picked-up image 131 includes the nail region 132. The printed region corresponding region 133 and the non-printed region corresponding region 134 are displayed so as to be disposed inside the nail region 132. The printed region corresponding region 133 and the non-printed region corresponding region 134 are displayed so as to be distinguished from each other.

For example, as shown in FIG. 8, the non-printed region corresponding region 134 is blank inside and the edge of the non-printed region corresponding region 134 is displayed on the display unit 13. The printed region corresponding region 133 is displayed on the display unit 13 without being blank inside.

Alternatively, as shown in FIG. 9, the non-printed region corresponding region 134 is displayed so as to be semi-transparent on the display unit 13 and the printed region corresponding region 133 is displayed so as to be non-transparent on the display unit 13. The semi-transparent display is the display in which each pixel value in the non-printed region corresponding region 134 is an average value between the pixel value of the non-printed region corresponding region 134 when displayed in non-transparent manner and the pixel value of the background.

Also, though not shown in the drawings, the non-printed region corresponding region 134 may be displayed so as to blink and the printed region corresponding region 133 may be constantly displayed.

In any case of the inside blank display (FIG. 8), the semi-transparent display (FIG. 9) and the blinking display, the remaining time calculated by the remaining time calculation unit 51i is displayed, inside the remaining time display region 135 numerically and the indication that the apparatus is in printing is displayed in the printing status display region 136.

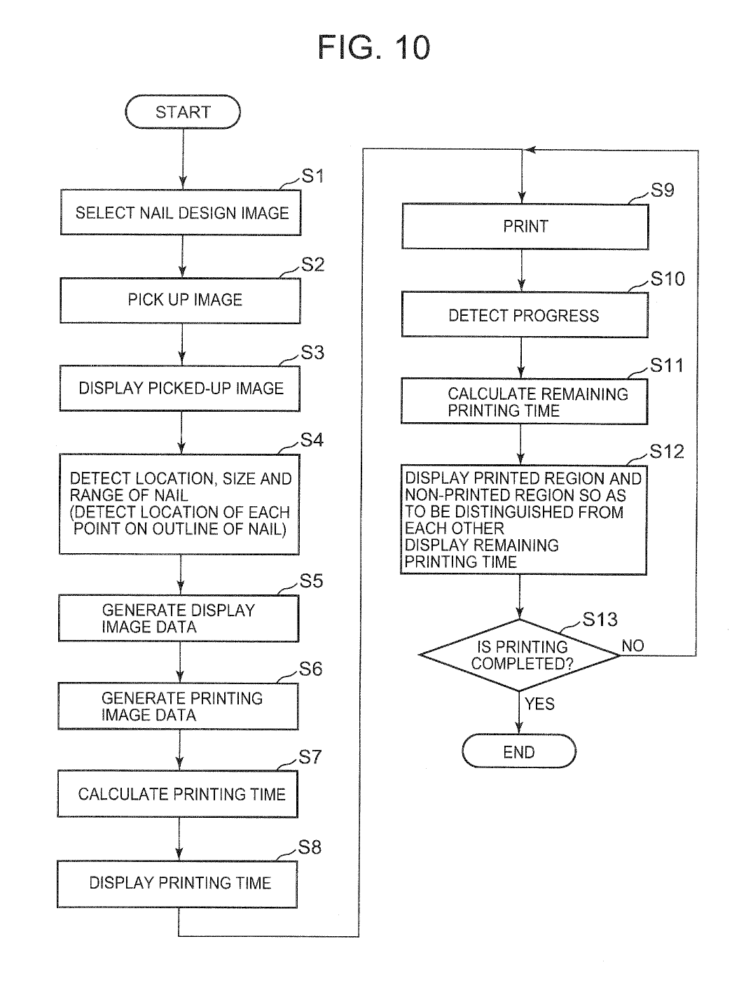

Subsequently, with reference to FIG. 10, flow of processing performed by the central control unit 51 according to the program 53 will be described and operation of the nail print apparatus 1 based on the processing performed by the central control unit 51 will be described.

When printing is to be performed by the nail print apparatus 1, first, a user turns on the power switch to activate the control device 50 and selects a nail design a user desires to print on a nail T of a printing finger U1 by the setting button 121 and the OK button 122 (step S1). A nail design is selected for each printing finger U1.

Specifically, the program 53 makes the central control unit 51 function as the printing image selection unit 51a and the display image selection unit 51b. Then, the central control unit 51 displays a plurality of printing nail design image data 54 stored in the program memory 52 on the display unit 13 as thumbnail images. Then, the user selects an image among the plurality of thumbnail images displayed on the display unit 13 by operating the setting button 121 and presses the OK button 122. According to the operation of the setting button 121 and the OK button 122 by the user, the central control unit 51 selects a printing nail design image data 54 among the plurality of printing nail design image data 54 stored in the program memory 52 and selects the display nail design image data 55 which corresponds to the selected printing nail design image data 54.

Then, the user inserts the printing finger U1 into the printing finger insertion unit 20a and places the printing finger U1 on the printing finger placement surface (upper surface of the dividing wall 21) with the nail T of the printing finger U1 facing up.

Next, when the user presses the print button 123, an operation signal indicating the operation is output from the print button 123 to the central control unit 51. Then, the program 53 makes the central control unit 51 function as the image pickup control unit 51c. The central control unit 51 which functions as the image pickup control unit 51c turns on the lights 33 and makes the electronic camera 32 perform image pickup operation (step S2). When the electronic camera 32 performs image pickup operation, a picked-up image including images of a finger and a nail is output by the electronic camera 32 and the central control unit 51 obtains the picked-up image.

Next, the central control unit 51 displays the picked-up image which was picked up by the electronic camera 32 on the display unit 13 (step S3).

Next, the program 53 makes the central control unit 51 function as the nail region detection unit 51d and the central control unit 51 detects the location, size and range of the nail T of the printing finger U1 on the basis of the picked-up image (step S4). That is, the central control unit 51 detects the location of each point on the edge of the nail region included in the picked-up image and converts the location (coordinate) of each point on the edge into the location (coordinate) of each point on the outline of the nail T.

Next, the program 53 makes the central control unit function as the display image data generation unit 51f. Then, the central control unit 51 converts the coordinate of each pixel of the selected display nail design image data 55 into the coordinate in the coordinate system of the picked-up image and generates the display image data (step S5). That is, the central control unit 51 changes the size and such like of the selected display nail design image data 55 and converts the coordinate of the display nail design image data 55 into the coordinate in the coordinate system of the picked-up image so as to dispose the display nail design image data 55 inside the edge of the nail region in the picked-up image.

Next, the program 53 makes the central control unit 51 function as the printing image data generation unit 51e. Then, the central control unit 51 converts the coordinate of each pixel of the selected printing nail design image data 54 into the coordinate in the XY orthogonal coordinate system and generates the printing image data (step S6). That is, the central control unit 51 changes the size and such like of the selected printing nail design image data 54 and converts the coordinate of the printing nail design image data 55 into the coordinate in the XY orthogonal coordinate system so as to dispose the printing nail design image data 54 inside the outline (the location of each point on the outline of the nail T is expressed in XY orthogonal coordinate system) of the nail T.

Next, the central control unit 51 calculates a printing time from the printing image data (step S7). The printing time is a period of time from the start of printing on the printing finger U1 by the printing unit 40 until the end of the printing.

Next, the central control unit 51 displays the printing time calculated in step S7 on the display unit 13 together with the picked-up image which was displayed in step S3 (step S8).

Next, the program 53 makes the central control unit 51 function as the printing control unit 51g and the central control unit 51 makes the printing unit 40 progress the printing operation by controlling the printing unit 40 via the print driver 60 (step S9). Therefore, the printing unit 40 prints the printing image data on the nail T of the printing finger U1.

Specifically, the central control unit 51 controls the motors 43 and 47 via the motor drivers 61 and 62, and thereby the print head 46 intermittently moves in the X direction and the Y direction above the nail T. That is, by the central control unit 51 making the motor 47 operate at predetermined intervals, the print, head 46 moves in the Y direction intermittently at predetermined intervals, and when the operation of the motor 47 stops, the print head 46 moves back and forth in the X direction by the central control unit 51 operating the motor 43. Then, when the print head 46 moves back and forth in the X direction, the central control unit 51 controls the print head 46 via the head driver 63 on the basis of the printing image data which is generated in step S6. Thereby, the print head 46 repeatedly sprays ink onto the nail T. Thus, an image according to the printing image data is formed on the nail T.

During the printing, the program 53 makes the central control unit 51 function as the progress detection unit 51h and the central control unit 51 discriminates between the printed region and the non-printed region in the printing image data (step S10). Also, the central control unit 51 discriminates between the printed region corresponding region and the non-printed region corresponding region in the display image data.

During the printing, the program 53 makes the central control unit 51 function as the remaining time calculation unit 51i and the central control unit 51 calculates the elapsed time from the start of printing and calculates the difference obtained by subtracting the elapsed time from the printing time calculated in step S7 (step S11). The difference is the remaining printing time.

Then, the program 53 makes the central control unit 51 function as the display control unit 51j, and as shown in FIGS. 8 and 9, the central control unit 51 distinguishes between the non-printed region corresponding region and the printed region corresponding region to display the regions on the display unit 13 (step S12). At that time, the central control unit combines the non-printed region corresponding region and the printed region corresponding region with the picked-up image so as to dispose the non-printed region corresponding region and the printed region corresponding region inside the edge of the nail region the picked-up image, and the central control unit 51 displays the non-printed region corresponding region and the printed region corresponding region on the display unit 13 together with the picked-up image. In addition, the central control unit 51 also displays the remaining printing time calculated in step S11 on the display unit 13. The remaining printing time is displayed in numerical value. Here, the central control unit 51 may display the printed region corresponding region on the display unit 13 without displaying the non-printed region corresponding region on the display unit 13 (see FIG. 7).

The central control unit 51 repeatedly performs the processing of the above steps S9 to S12 (step S13: NO). Accordingly, printing is continued by the printing unit 40 (step S9), the non-printed region corresponding region and the printed region corresponding region are displayed so as to be distinguished from each other (step S12) and the remaining printing time is also displayed (step S12). Every time the processing of steps S9 to S12 is performed, the central control unit 51 detects the progress (step S10) and calculates the remaining printing time (step S12). Therefore, the remaining printing time displayed on the display unit 13 decreases, the area of the non-printed region corresponding region also decreases and the area of the printed region corresponding region increases.

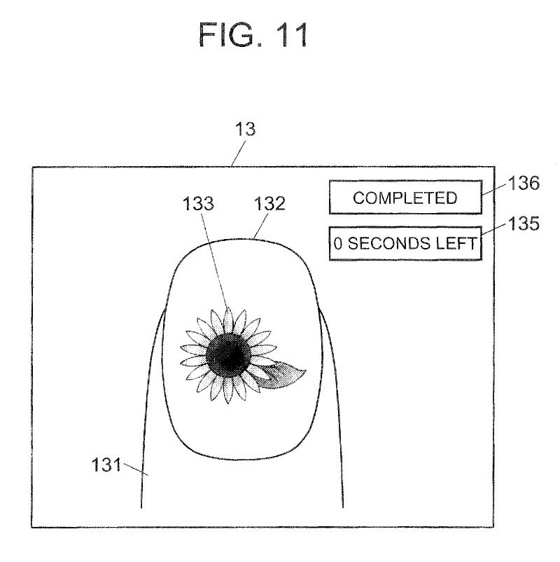

Then, when the printing ends for the entire region of the printing image data (step S13: YES), as shown in FIG. 11, the entire region of the display image data is the printed region corresponding region 133 and the entire display image data is displayed on the display unit 13. Thereafter, the central control unit 51 ends the processing shown in FIG. 10.

Thereafter, when printing is to be performed on the nail T of the next printing finger U1, the central control unit 51 performs the processing shown in FIG. 10 again.

As described above, according to the nail print apparatus 1 in the embodiment, a user can intuitively recognize the period of time in which a printing finger U1 of a nail T under printing should not be moved because the progress of printing is displayed on the display unit 13. Therefore, the user can enjoy the nail design process with comfort.

Here, when the printed region and the non-printed region are displayed on the display unit so as to be distinguished from each other, not only the remaining time calculated by the remaining time calculation unit may be displayed, but also the total printing time may be displayed on the display unit. Further, printing progress status may be displayed on the display unit, in a form of a bar (bar display) or in a form by percentage (percentage display), wherein the printing progress status is obtained by dividing the time already required for printing which is obtained by subtracting the remaining time from the total printing time by the total printing time. The bar display may be such that the bar merely changes by a rough rate such as in units of ¼ of a bar, in units of ⅕ of a bar and in units of ⅛ of a bar without a display of the detailed printing status. In such way, it can be grasped as an image in the mind how much longer the finger must be kept still in order to perform printing.

Also, a user can intuitively recognize the period of time until the start of printing on the nail T of the next printing finger U1. Therefore, a user can know that when the user feels discomfort in the next printing finger U1 during printing on the printing finger U1, the user can move the next printing finger U1.

Though the embodiment of the present invention has been described, the scope of the present invention is not limited to the above-mentioned embodiment and includes the scope of the invention described in claims and the equivalent thereof.

According to one aspect of the preferred embodiments of the present invention, there is provided a nail print apparatus, including a print head which performs printing on a fingernail of a user; a display unit; and a display control unit which displays a printing image on the display unit so that the user can distinguish between a printed region and a non-printed region in the printing image being printed on the nail.

Preferably, the nail print apparatus further includes a printing control unit which controls the print head to progress printing of the printing image by the print, head; and a progress detection unit which discriminates between the printed region and the non-printed region according to a printing status of the print head which is controlled by the printing control unit, wherein the display control unit, displays the printing image on the display unit on the basis of image data.

Preferably, the display control unit does not display a non-printed region corresponding region which corresponds to the non-printed region discriminated by the progress detection unit.

Preferably, the display control unit displays a printed region corresponding region on the display unit constantly and displays the non-printed region corresponding region on the display unit so as to blink.

Preferably, the display control unit displays the non-printed region corresponding region on the display unit so as to be semi-transparent and displays the printed region corresponding region on the display unit so as to be non-transparent.

Preferably, the display control unit displays an edge of the non-printed region corresponding region on the display unit by making inside of the non-printed region corresponding region blank and displays the printed area corresponding area on the display unit without making inside of the printed region corresponding region blank.

Preferably, The nail print apparatus further including a remaining time calculation unit which calculates a remaining time until the printing being progressed by the printing control unit ends, wherein the display control unit displays the printed region corresponding region and the non-printed region corresponding region together with the remaining time calculated by the remaining time calculation unit on the display unit.

Preferably, the display control unit displays a total printing time on the display unit.

Preferably, the display control unit displays as printing progress status on the display unit in a form of a bar or in a form by percentage, the printing progress status being obtained by dividing a time which is already required for printing by the total printing time, wherein the time which is already required for printing is obtained by subtracting the remaining time from the total printing time.

Preferably, the image data is generated from an image which is stored in a program memory.

Preferably, the display control unit compares a data amount of an image to be printed on the nail and a data amount which is already printed, and displays the image for a proportion of, the data amount which is already printed on the display unit as the printed region.

Preferably, the display control unit compares an estimated printing time period to perform printing on the nail and a time period elapsed from start of print the nail, and displays the image for a proportion of the time period elapsed from tart of printing on the nail on the display unit as the printed region.

Preferably, the display control unit compares a movement amount of the print head which is estimated from an image area to be printed on the nail and a movement amount of the print head moved from start of printing on the nail, and displays the image for a proportion of the movement, amount of the print head moved from start of printing on the nail on the display unit as the printed region.

The entire disclosure of Japanese Patent Application. No. 2011-236657 filed on Oct. 28, 2011 including description, claims, drawings, and abstract are incorporated herein by reference in its entirety.

What is claimed is:

1. A nail print apparatus, comprising:
a print head which performs printing on a fingernail of a user;
a display unit; and
a display control unit which displays a printing image on the display unit so that the user can distinguish between a printed region and a non-printed region in the printing image being printed on the nail.

2. The nail print apparatus according to claim 1, further comprising:
a printing control unit which controls the print head to progress printing of the printing image by the print head; and
a progress detection unit which detects printing condition of the printing which is being controlled by the printing control unit to discriminate between the printed region and the non-printed region, wherein
the display control unit displays the printing image on the display unit based on image data while the printing.

3. The nail print apparatus according to claim 2, wherein
the display control unit does not display a non-printed region corresponding region which corresponds to the non-printed region discriminated by the progress detection unit.

4. The nail print apparatus according to claim 2, wherein
the display control unit displays a printed region corresponding region on the display unit, constantly and displays the non-printed region corresponding region on the display unit so as to blink.

5. The nail print apparatus according to claim wherein
the display control unit displays the non-printed region corresponding region on the display unit so as to be semi-transparent and displays the printed region corresponding region on the display unit so as to be non-transparent.

6. The nail print, apparatus according to claim 2, wherein
the display control unit displays an edge of the non-printed region corresponding region on the display unit by making inside of the non-printed region corresponding region blank and displays the printed region corresponding region on the display unit without making inside of the printed region corresponding region blank.

7. The nail print apparatus according to claim 2, further comprising:
a remaining time calculation unit which calculates a remaining time until the printing being progressed by the printing control unit ends, wherein
the display control unit displays the printed region corresponding region and the non-printed region corresponding region together with the remaining time calculated by the remaining time calculation unit on the display unit.

8. The nail print apparatus according to claim 7, wherein
the display control unit displays a total printing time on the display unit.

9. The nail print apparatus according to claim 8, wherein
the display control unit displays a printing progress status on the display unit in a form of a bar or in a form by percentage, the printing progress status being obtained by dividing a time which is already required for printing by the total printing time, wherein the time which is already required for printing is obtained by subtracting the remaining time from the total printing time.

10. The nail print apparatus according to claim 2, further comprising a program memory that stores the image data.

11. The nail print apparatus according to claim 2, wherein
the display control unit compares a data amount of an image to be printed on the nail and a data amount which is already printed, and displays the image for a proportion of the data amount which is already printed on the display unit as the printed region.

12. The nail print apparatus according to claim 2, wherein
the display control unit compares an estimated printing time period to perform printing on the nail and a time period elapsed from start of printing on the nail, and displays the image for a proportion of the time period elapsed from start of printing on the nail on the display unit as the printed region.

13. The nail print apparatus according to claim 2, wherein
the display control unit compares a movement amount of the print head which is estimated from an image area to be printed on the nail and a movement amount of the print head moved from start of printing on the nail, and displays the image for a proportion of the movement amount of the print head moved from start of printing on the nail on the display unit as the printed region.
